(19) United States
(12) Patent Application Publication
(10) Pub. No.: US 2019/0029464 A1
(43) Pub. Date: Jan. 31, 2019

(54) AUTOMATIC TEA MAKER

(71) Applicant: HongKong TAYAYO Electrical Technologies Co., Limited, Hong Kong (HK)

(72) Inventor: Taiyang Qiu, Hong Kong (HK)

(21) Appl. No.: 15/787,702

(22) Filed: Oct. 18, 2017

(30) Foreign Application Priority Data
Jul. 27, 2017 (CN) 201720937120.3

(51) Int. Cl. A47J 31/44; A47J 31/06

(52) U.S. Cl. CPC A47J 31/4403; A47J 31/06

(57) ABSTRACT

An automatic tea maker includes a brewing container, a support frame, a control unit, and a power supply module. A bottom wall of the brewing container is provided with a water outlet and a plug for plugging the water outlet. The support frame includes an upper support portion for supporting the brewing container, a lower support portion for supporting a cup, and a support plate connected with the upper support portion and the lower support portion. The upper support portion has a through hole corresponding to the water outlet. The upper support portion is provided with a lever for pushing the pin. The lever is provided with an electromagnet for driving the lever. The lower support portion is slidably connected with a turntable. One side of the turntable is provided with a motor for driving the turntable to slide. The lower support portion is provided with an infrared sensor.

### CROSS-REFERENCE TO RELATED APPLICATIONS

This present invention claims the benefit of Chinese Patent Application No. 201720937120.3, filed on Jul. 27, 2017; the contents of which are hereby incorporated by reference.

### FIELD OF THE INVENTION

The present invention relates to a tea maker, and more particularly to an automatic tea maker.

### BACKGROUND OF THE INVENTION

Since the stand of living is higher and higher, there is an increasing concern for the smart home. In general, people use a tea set for brewing tea. When in use, the user holds a tea pot to pour out tea with his/her hands. Because the temperature of the tea is too high, the tea may scald the user's hands. In this way, it is inconvenient for the user to pour out the tea. Before brewing tea, tea leaves need to be rinsed. Sometimes, the tea leaves may flow out of the tea pot when the rinse water is poured out.

Moreover, various tea leaves from different origins require different brewing time and water temperature. For those who are unfamiliar with the tea brewing skill, they are unable to brew good tea for superior tea leaves to cause a waste of superior tea leaves. These days, the pace of life is faster and faster with technological advancements. People don't have much time to brew tea. Especially for those who like to drink tea, their life will lack a lot of fun. There is a need to consider a safe and environmentally friendly and smart tea maker. Accordingly, the inventor of the present invention has devoted himself based on his many years of practical experiences to solve these problems.

### SUMMARY OF THE INVENTION

The primary object of the present invention is to overcome the shortcomings of the prior art and to provide an automatic tea maker.

In order to achieve the aforesaid object, the automatic tea maker of the present invention comprises a brewing container for brewing tea. The automatic tea maker further comprises a support frame, a control unit, and a power supply module. A bottom of the brewing container is provided with an elastic steel sheet and a pin for controlling movement of the elastic steel sheet. A bottom wall of the brewing container is provided with a water outlet and a plug for plugging the water outlet. One end of the elastic steel sheet is fixedly connected to the brewing container. Another end of the elastic steel sheet is fixed to the plug. A first filter screen is provided above the water outlet. The support frame includes an upper support portion for supporting the brewing container, a lower support portion for supporting a cup, and a support plate connected with the upper support portion and the lower support portion. The upper support portion has a through hole corresponding to the water outlet. The upper support portion is provided with a lever for pushing the pin. The lever is provided with an electromagnet for driving the lever. The lower support portion is slidably connected with a turntable for placing the cup. One side of the turntable is provided with a motor for driving the turntable to slide. The lower support portion is provided with an infrared sensor. The power supply module, the motor, the infrared sensor and the electromagnet are electrically connected with the control unit.

When the electromagnet is energized, an inner end of the lever is lifted to push the pin upward, the plug is moved up, and the water outlet is opened. When the electromagnet is deenergized, the inner end of the lever descends, the elastic steel sheet is moved downward by its elasticity, the plug is moved downward, and the water outlet is closed.

Preferably, the control unit includes a communication module communicated with a remote mobile terminal via Internet. The control unit further includes a storage module.

Preferably, the automatic tea maker further comprises an electric heating element and a temperature sensor disposed at an inner side of the brewing container and electrically connected with the control unit, and an electric pump connected with brewing container. The electric pump is electrically connected with the control unit.

Preferably, the automatic tea maker further comprises a control button and a display screen which are electrically connected with the control unit.

Preferably, the cup comprises a rinse water cup for containing rinse water and a tea cup for containing tea.

Preferably, the automatic tea maker further comprises a filter. The filter includes a second filter screen and a frame for supporting the second filter screen. The filter is inserted into a slot of the upper support portion and corresponds in position to the water outlet.

Preferably, a first sealing ring is provided between the frame and the slot. A tea buffer chamber is defined between the second filter screen and the frame.

Preferably, the upper support portion has an upper accommodation trough for accommodating the brewing container. The turntable has a lower accommodation trough for accommodating the cup.

Preferably, the upper support portion and the lower support portion are horizontally slidably connected to the support plate, respectively.

Preferably, the lever is hingedly connected to the upper support portion. One end of the lever extends out of a front of the upper support portion. The front of the upper support portion is provided with a locking groove for holding the lever in a pressed state. A bottom of the locking groove is provided with a delay ejector.

Compared to the prior art, the beneficial effects of the present invention are described below. The automatic tea maker can prevent the user from directly touching the brewing container, thereby reducing scald accidents. It is convenient and easy to rinse tea leaves and brew tea. The structure is simple. The automatic tea maker of the present invention provides an automatic brewing process for various tea leaves, instead of the complicated manual tea brewing process, to achieve intelligent control. The control unit includes the communication module which can be used for remote control to save time and improve the living efficiency.

### BRIEF DESCRIPTION OF THE DRAWINGS

FIG. 1 is a schematic view of the automatic tea maker of the present invention;

FIG. 2 is a sectional view of the automatic tea maker of the present invention; and

FIG. 3 is a block diagram of the control circuit of the automatic tea maker of the present invention.

### DETAILED DESCRIPTION OF THE PREFERRED EMBODIMENTS

Embodiments of the present invention will now be described, by way of example only, with reference to the accompanying drawings.

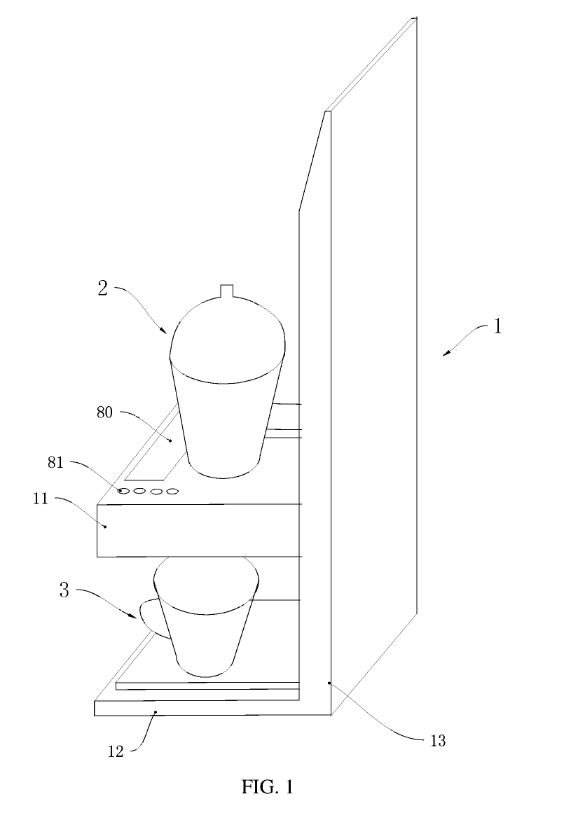

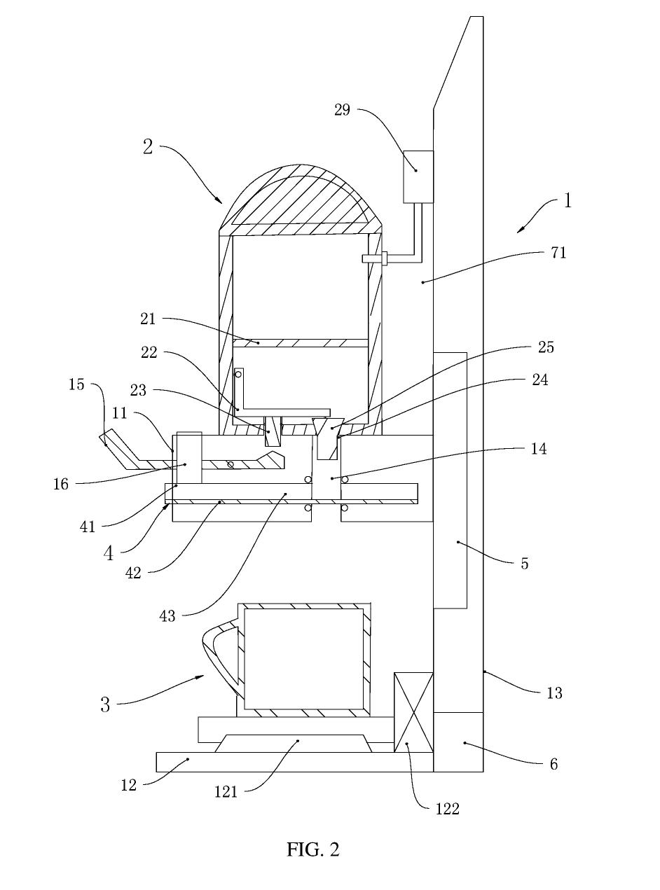

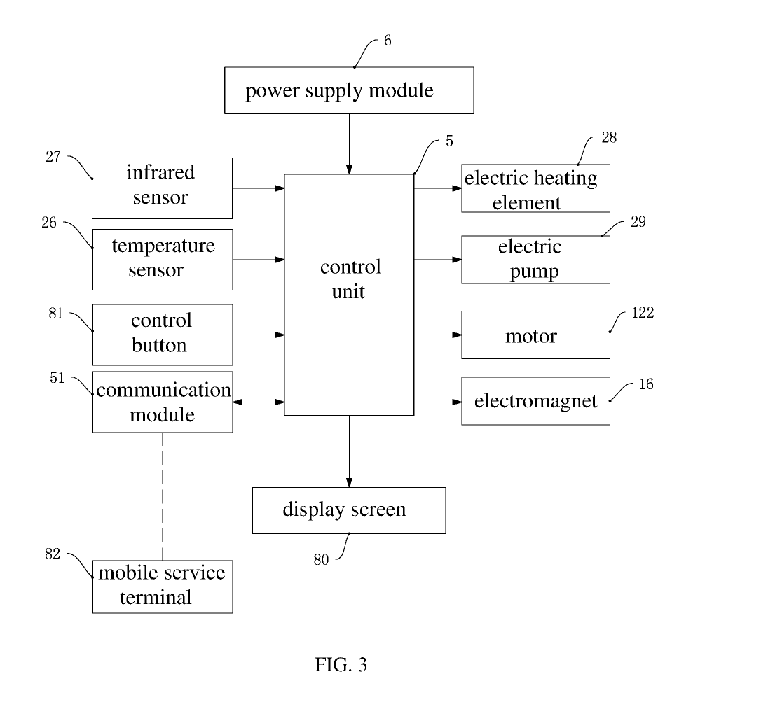

FIG. 1 and FIG. 2 illustrate the structure of an embodiment of the present invention. FIG. 3 is a block diagram of the control circuit of the embodiment of the present invention.

The present invention discloses an automatic tea maker. The automatic tea maker comprises a brewing container 2 for brewing tea. The automatic tea maker further comprises a support frame 1. In addition, in order to increase the intelligence of the automatic tea maker, the automatic tea maker further comprises a control unit 5 and a power supply module 6.

The bottom of the brewing container 2 is provided with an elastic steel sheet 22 and a pin 23 for controlling the movement of the elastic steel sheet 22. The bottom wall of the brewing container 2 is provided with a water outlet 24 and a plug 25 for plugging the water outlet 24. One end of the elastic steel sheet 22 is fixedly connected to the brewing container 2, and another end of the elastic steel sheet 22 is fixed to the plug 25. A first filter screen 21 is provided above the water outlet 24. The support frame 1 includes an upper support portion 11 for supporting the brewing container 2, a lower support portion 12 for supporting a cup 3, and a support plate 13 connected with the upper support portion 11 and the lower support portion 12. The upper support portion 11 has a through hole 14 corresponding to the water outlet 24. The upper support portion 11 is provided with a lever 15 for pushing the pin 23. The lever 15 is provided with an electromagnet 16 for driving the lever 15. The lower support portion 11 is slidably connected with a turntable 121 for placing the cup 3. One side of the turntable 121 is provided with a motor 122 for driving the turntable 121 to slide.

The power supply module 6, the motor 122, an infrared sensor 27, and the electromagnet 16 are electrically connected with the control unit 5.

When the cup 3 is placed on the turntable 121, the infrared sensor 27 detects and transmits a signal to the control unit 5. After the control unit 5 receives the signal, the signal is processed and calculated and then transmitted to the electromagnet 16 to energize the electromagnet 16. When an inner end of the lever 15 is lifted to push the pin 23 upward, the plug 25 is moved up and the water outlet 24 is opened. When the cup 3 is removed, the infrared sensor 27 detects and transmits a signal to the control unit 5. After the control unit 5 receives the signal, the signal is processed and calculated and then transmitted to the electromagnet 16 to deenergize the electromagnet 16. When the inner end of the lever 15 descends, the elastic steel sheet 22 is moved downward by is elasticity, and the plug 25 is moved downward, and the water outlet 24 is closed.

As described above, by the automatic control of the electromagnet 16, the present invention realizes an intelligent control, without a manual operation to pour tea.

For further intelligence, the control unit 5 further includes a communication module 51 communicated with a mobile service terminal 82. The connection of the mobile service terminal may be any one of Internet, a wireless Bluetooth device, WiFi, and an infrared ray. On the basis of the aforesaid, in order to remotely control tea brewing, an inner side of the brewing container 2 is provided with an electric heating element 28 and a temperature sensor 26 which are electrically connected with the control unit 5, and an electric pump 29 having a pipe connected to the outside of the automatic tea maker. The electric pump 29 is electrically connected with the control unit 5. The temperature of the water is detected by the temperature sensor 26, so that tea leaves can be brewed at the most suitable water temperature.

Remote control has many advantages, for example, through a mobile phone app to achieve remote control for brewing tea. It is quite convenient to entertain guests. For example, when the host drives the customer to the company or home, he/she can perform remote control for brewing tea in advance on the way home. When they reach the company or home, they may have tea immediately, without waiting for some time.

Preferably, the automatic tea maker further comprises a control button 81 and a display screen 80 which are electrically connected with the control unit 5 for convenience of control and operation.

Preferably, the control unit 5 further includes a storage module. The storage module stores parameters, such as brewing time and water temperature for a variety of tea leaves. According to individual preferences, the user just selects the desired mode and tea leaves, the automatic tea maker can automatically rinse tea leaves and brew tea according to the set time and water temperature of the system, instead of the complicated manual tea brewing process. The intelligent tea maker makes tea leaves more tastable.

Preferably, the cup 3 placed on the turntable 121 comprises a rinse water cup for containing rinse water and a tea cup for containing tea. In order to realize the automatic process for rinsing tea leaves and brewing tea, the lower support portion 12 is provided with the turntable 121 driven by the motor 122 which is electrically connected with the control unit 5, such that the turntable 121 can slid left and right. A tea cup and a rinse water cup are placed on the turntable 121. When tea leaves are rinsed, the rinse water cup is to contain the rinse water. When tea leaves are brewed, the turntable is turned for the tea cup to contain the brewed tea. In this way, tea leaves can be rinsed and brewed automatically. Through the communication module and the Internet, the user can remotely control the tea brewing process so that the automatic tea maker becomes a smart product.

When the pin 23 of the brewing container 2 is controlled by the elastic steel sheet 22 to open the plug 25, the tea flows from the water outlet 24 to the cup 3. When the pin 23 is controlled by the elastic steel sheet 22 to close the plug 25, the tea is kept in the brewing container 2.

Tea leaves are placed on the first filter screen 21, the water is poured into the brewing container 2 to rinse the tea leaves, the elastic steel sheet 22 controls the plug 25 to open the water outlet 24, and the rinse water flows out from the water outlet 24. After that, the water outlet 24 is closed and the water is poured into the brewing container 2, and the elastic steel sheet 22 controls the plug 25 to open the water outlet 24, and the brewed tea flows from the water outlet 24 to the cup 3. The whole process is full automatic to prevent the user's hand from directly touching the brewing container 2, reducing scald accidents. It is convenient to brew tea.

Specifically, as shown in FIG. 2, the automatic tea maker further includes a filter 4. The filter 4 includes a second filter screen 42 and a frame 41 for supporting the second filter screen 42. The filter 4 is inserted into a slot of the upper support portion 11 and corresponds in position to the water outlet 24. A first sealing ring is provided between the frame 41 and the slot. A tea buffer chamber 43 is defined between the second filter screen 42 and the frame 41. The pin 23 passes through the bottom of the brewing container 2 and supports the elastic steel sheet 22. The automatic tea maker further includes the lever 15 which has a linkage relationship with the pin 23. The lever 15 controls the elastic steel sheet 22 to rotate around the inner wall of the brewing container 2 through the pin 23. The upper support portion 11 has an upper accommodation trough for accommodating the brewing container 2. The turntable 121 of the lower support portion 12 has a lower accommodation trough for accommodating the cup 3. The upper support portion 11 and the lower support portion 12 are horizontally slidably connected to the support plate 13, respectively.

Preferably, when the power is off, the lever 15 is pressed and controls the elastic steel sheet 22 to rotate around the inner wall of the brewing container 2 through the pin 23 for controlling the opening and closing of the water outlet 24.

The lever 15 is hingedly connected to the upper support portion 11. One end of the lever 15 extends out of the front of the upper support portion 11. The front of the upper support portion 11 is provided with a locking groove (not shown) for holding the lever 15 in a pressed state.

The bottom of the locking groove is provided with a delay ejector (not shown). The delay ejector is pressed against the side of the lever 15 by means of a mechanically adjustable button (such as a switch knob) to disengage the lever 15 from the locking groove and return to its original position. Under the action of the elastic steel plate 22 and the hydraulic pressure, the plug 25 is moved down to close the water outlet 24. This structure can set the outflow of the tea each time by means of the switch knob.

In view of the above, the automatic tea maker of the present invention can prevent the user from directly touching the brewing container, thereby reducing scald accidents. It is convenient and easy to rinse tea leaves and brew tea. The structure is simple. The automatic tea maker of the present invention provides an automatic brewing process for various tea leaves, instead of the complicated manual tea brewing process, to achieve intelligent control. The control unit includes the communication module which can be used for remote control to save time and improve the living efficiency.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An automatic tea maker, comprising a brewing container for brewing tea, characterized by: the automatic tea maker further comprising a support frame, a control unit, and a power supply module; a bottom of the brewing container being provided with an elastic steel sheet and a pin for controlling movement of the elastic steel sheet; a bottom wall of the brewing container being provided with a water outlet and a plug for plugging the water outlet; one end of the elastic steel sheet being fixedly connected to the brewing container, another end of the elastic steel sheet being fixed to the plug; a first filter screen being provided above the water outlet; the support frame including an upper support portion for supporting the brewing container, a lower support portion for supporting a cup, and a support plate connected with the upper support portion and the lower support portion, the upper support portion having a through hole corresponding to the water outlet; the upper support portion being provided with a lever for pushing the pin; the lever being provided with an electromagnet for driving the lever; the lower support portion being slidably connected with a turntable for placing the cup, one side of the turntable being provided with a motor for driving the turntable to slide; the lower support portion being provided with an infrared sensor, the power supply module, the motor, the infrared sensor and the electromagnet being electrically connected with the control unit;
wherein when the electromagnet is energized, an inner end of the lever is lifted to push the pin upward, the plug is moved up, and the water outlet is opened; when the electromagnet is deenergized, the inner end of the lever descends, the elastic steel sheet is moved downward by its elasticity, the plug is moved downward, and the water outlet is closed.

2. The automatic tea maker as claimed in claim 1, wherein the control unit includes a communication module communicated with a remote mobile terminal via Internet; the control unit further includes a storage module.

3. The automatic tea maker as claimed in claim 2, further comprising an electric heating element and a temperature sensor disposed at an inner side of the brewing container and electrically connected with the control unit, and an electric pump connected with brewing container; the electric pump being electrically connected with the control unit.

4. The automatic tea maker as claimed in claim 1, further comprising a control button and a display screen which are electrically connected with the control unit.

5. The automatic tea maker as claimed in claim 1, wherein the cup comprises a rinse water cup for containing rinse water and a tea cup for containing tea.

6. The automatic tea maker as claimed in claim 1, further comprising a filter, the filter including a second filter screen and a frame for supporting the second filter screen, the filter being inserted into a slot of the upper support portion and corresponds in position to the water outlet.

7. The automatic tea maker as claimed in claim 6, wherein a first sealing ring is provided between the frame and the slot; and a tea buffer chamber is defined between the second filter screen and the frame.

8. The automatic tea maker as claimed in claim 6, wherein the upper support portion has an upper accommodation trough for accommodating the brewing container; and the turntable has a lower accommodation trough for accommodating the cup.

9. The automatic tea maker as claimed in claim 1, wherein the upper support portion and the lower support portion are horizontally slidably connected to the support plate, respectively.

10. The automatic tea maker as claimed in claim 1, wherein the lever is hingedly connected to the upper support portion, one end of the lever extends out of a front of the upper support portion; the front of the upper support portion is provided with a locking groove for holding the lever in a pressed state, and a bottom of the locking groove is provided with a delay ejector.
